(19) United States
(12) Patent Application Publication
(10) Pub. No.: US 2026/0120916 A1
(43) Pub. Date: Apr. 30, 2026

(54) WIRE HARNESS

(71) Applicant: YAZAKI CORPORATION, Tokyo (JP)

(72) Inventor: Tsubasa Kawai, Makinohara-shi (JP)

(21) Appl. No.: 19/430,277

(22) Filed: Dec. 23, 2025

Related U.S. Application Data
(63) Continuation of application No. PCT/JP2024/022701, filed on Jun. 24, 2024.

(30) Foreign Application Priority Data
Jul. 27, 2023 (JP) 2023-122124

(51) Int. Cl. H01B 7/00; H02G 3/32

(52) U.S. Cl. CPC H01B 7/0045; H02G 3/32

(57) ABSTRACT

A wire harness includes a wiring member having conductivity, and a molded member that is an exterior member of the wiring member and provided integrally with the wiring member so as to cover the wiring member, the molded member includes a plurality of slits formed from an outer surface of the molded member toward a side on which the wiring member is located, and when the molded member is molded using a mold, a position of the wiring member with respect to the molded member can be restricted by ribs of the mold that form the slits of the molded member, and the wiring member can be disposed at an appropriate position.

### CROSS-REFERENCE TO RELATED APPLICATION(S)

This application is a continuation application of International Application No. PCT/JP2024/022701 filed on Jun. 24, 2024 which claims the benefit of priority from Japanese Patent Application No. 2023-122124 filed on Jul. 27, 2023 and designating the U.S., the entire contents of which are incorporated herein by reference.

### BACKGROUND OF THE INVENTION

### 1. Field of the Invention

The present invention relates to a wire harness.

### 2. Description of the Related Art

In a wire harness, an exterior material is indispensable for protecting an electric wire from an external structure such as an iron plate of a vehicle. In conventional wire harnesses, various types of exterior materials are used for protecting electric wires. For example, a wire harness described in JP 2019-160 568 A includes an electric wire bundle and a molded body integrally provided on an attachment portion that is a part of the electric wire bundle in an axial direction, and the molded body is made of a thermoplastic resin.

However, in the conventional wire harnesses, since there are various types of exterior members, there are many exterior members that can be attached to an electric wire only manually. That is, there are various types of exterior members, and some exterior members require manual adjustment of disposition in disposing a wiring member such as an electric wire at an appropriate position of the exterior member. Therefore, in the conventional wire harnesses, there is room for improvement from the viewpoint of attachment of the exterior member to the wiring member.

### SUMMARY OF THE INVENTION

The present invention has been made in view of the above, and an object of the present invention is to provide a wire harness capable of easily disposing a disposition position of a wiring member at an appropriate position with respect to an exterior member and attaching the exterior member to the wiring member.

In order to achieve the above mentioned object, a wire harness according to one aspect of the present invention includes a wiring member having conductivity; and a molded member that covers the wiring member and is provided integrally with the wiring member; and a protrusion that protrudes from an outer surface of the molded member, wherein the molded member includes a plurality of slits formed from an outer surface of the molded member toward a side on which the wiring member is located.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a perspective view of a wire harness according to an embodiment;

FIG. 2 is a side view of the wire harness illustrated in FIG. 1;

FIG. 3 is a cross-sectional view taken along line A-A of FIG. 1;

FIG. 4 is a perspective view of a main part including a cross section taken along line B-B in FIG. 1;

FIG. 5 is a perspective view of a main part including a cross section taken along line C-C in FIG. 1;

FIG. 6 is a perspective view of a mold used for molding a molded member;

FIG. 7 is a perspective view illustrating a state in which an upper mold and a lower mold of the mold illustrated in FIG. 6 are separated;

FIG. 8 is a perspective view of the upper mold and the lower mold illustrated in FIG. 7 as viewed from the lower mold side;

FIG. 9 is a cross-sectional view of the mold illustrated in FIG. 6 at a position of the wire harness;

FIG. 10 is a plan view of a molded member in which slits are inclined with respect to an extending direction of wiring members, which is a modification of the wire harness according to the embodiment;

FIG. 11 is a plan view of a molded member in which second slits are inclined in the same direction as first slits, which is a modification of the wire harness according to the embodiment;

FIG. 12 is a plan view of a molded member in which second slits are inclined in a direction different from that of first slits, which is a modification of the wire harness according to the embodiment;

FIG. 13 is a side view of a molded member in which second slits are formed, which is a modification of the wire harness according to the embodiment; and

FIG. 14 is a plan view of a molded member in which fixing portions for attaching a molded member to an attachment target portion are disposed, which is a modification of the wire harness according to the embodiment.

### DETAILED DESCRIPTION OF THE PREFERRED EMBODIMENTS

Hereinafter, an embodiment according to the present invention will be described in detail with reference to the drawings. Note that this invention is not limited by this embodiment. In addition, the constituent elements in the embodiment described below include those that can be easily replaced by those skilled in the art or those that are substantially the same.

### Embodiment

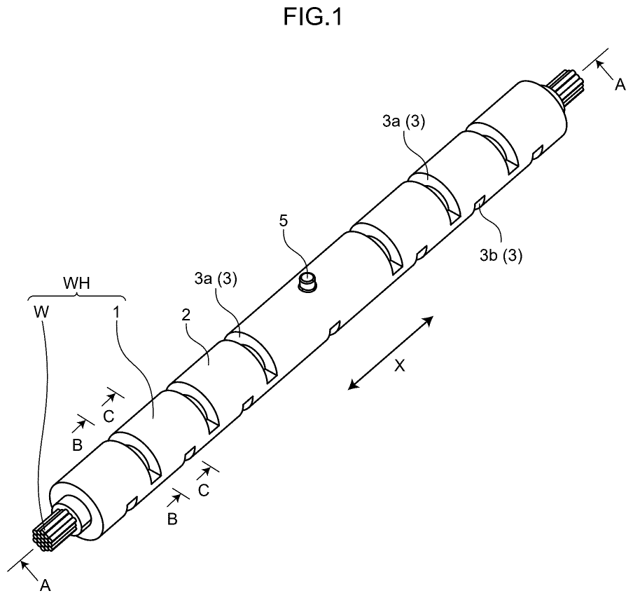

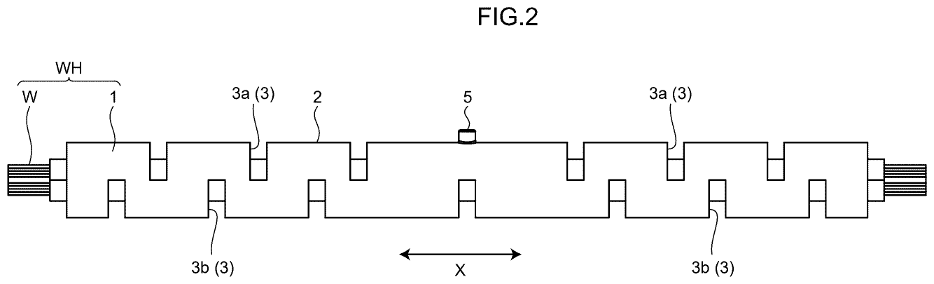

FIG. 1 is a perspective view of a wire harness WH according to an embodiment. FIG. 2 is a side view of the wire harness WH illustrated in FIG. 1. The wire harness WH according to the present embodiment is routed in a vehicle or the like. For example, the wire harness WH is configured such that a plurality of wiring members W used for power supply and signal communication is bundled into a collective component for connection between devices mounted on a vehicle, and the plurality of wiring members W is electrically connected to the devices by connectors or the like. The wire harness WH includes the plurality of wiring members W having conductivity, and a molded member 1 integrally provided around the plurality of wiring members W so as to bundle the plurality of wiring members W. The wire harness WH may be configured to further include, in addition to the above, various components such as a corrugated tube, a resin tape, an exterior member such as a protector, an electrical connection box, and a fixing tool.

The wiring member W is composed of, for example, a metal rod, an electric wire, an electric wire bundle, or the like. The metal rod is a rod-shaped member having conductivity. The electric wire is a conductor portion (core wire) made of a plurality of metal wires having conductivity. The electric wire bundle is a bundle of the electric wires. Note that each of the wiring members W may be covered with a covering portion having an insulating property.

The molded member 1 is provided as an exterior member with respect to the wiring members W. The molded member 1 is provided around the plurality of wiring members W so as to cover the plurality of wiring members W so that the plurality of wiring members W is bundled along a predetermined direction (hereinafter, referred to as an extending direction X) in which the plurality of wiring members W extends. The molded member 1 is formed of, for example, an insulating elastic resin material (for example, ethylene-propylene-diene rubber (EPDM) or the like) having low rigidity and high flexibility, such as rubber or thermoplastic elastomer. In the molded member 1, the elastic resin material is integrally provided by molding around the plurality of wiring members W so as to bundle the plurality of wiring members W. Therefore, the wire harness WH can have flexibility together with the molded member 1. The molded member 1 collectively covers a partial section of the plurality of wiring members W, and the section of the plurality of wiring members W is embedded. Note that the covering portion constituting the wiring member W is typically an insulating covering member provided over the entire length of the wiring members W, whereas the molded member 1 is a protective member partially provided at a necessary portion of the wiring members W, such as for protection and route regulation of the wiring members W on the further outer side of such a covering member.

In the present embodiment, the molded member 1 is formed in a substantially cylindrical shape in which the axial direction is a direction along the extending direction X of the wiring members W. The plurality of wiring members W is disposed about the axis of the cylinder that is the shape of the molded member 1 inside the molded member 1.

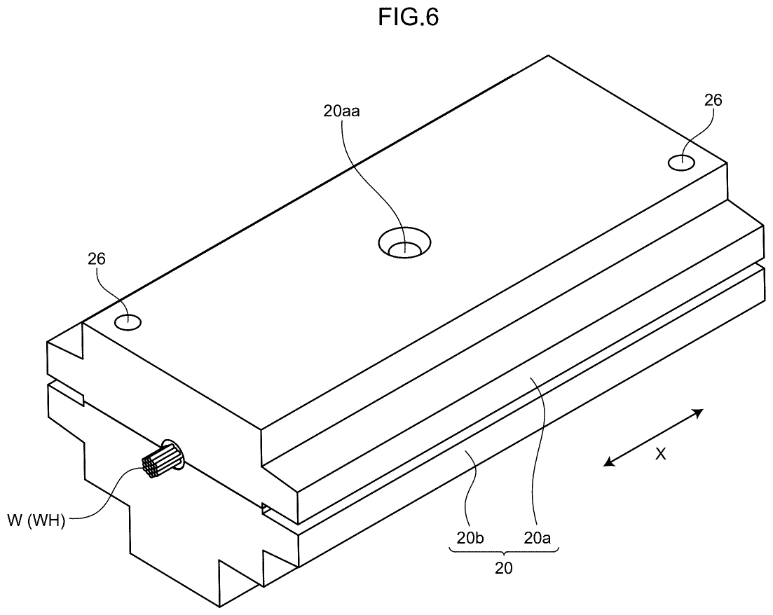

In addition, in the molded member 1 according to the present embodiment, a protrusion 5, which is a gate mark when the molded member 1 is formed by injection molding, protrudes from an outer surface 2 of the molded member 1 and is formed on a part of the outer surface 2. That is, the protrusion 5 formed on the outer surface 2 of the molded member 1 is a mark of an injection portion of the resin material into a mold 20 (see FIG. 6) when the molded member 1 is injection-molded using the mold 20. The protrusion 5 is formed on the outer surface 2 near the center of the molded member 1 in the extending direction X of the wiring members W.

The molded member 1 includes a plurality of slits 3 formed from the outer surface 2 of the molded member 1 toward the side on which the wiring members W are located. That is, since the molded member 1 covers the plurality of wiring members W and the wiring members W are disposed inside the molded member 1, the plurality of slits 3 formed in the molded member 1 is formed from the outer surface 2 of the molded member 1 toward the inside of the molded member 1.

Each of the plurality of slits 3 formed in the molded member 1 in this manner is formed such that the longitudinal direction of the slit 3 is an orientation orthogonal to the extending direction X of the wiring members W. In other words, each slit 3 is formed in an orientation in which a width direction of the slit 3 is the extending direction X of the wiring members W.

In addition, the slits 3 are formed on both sides of the molded member 1 across the wiring members W. Specifically, the plurality of slits 3 is formed on both sides across the wiring members W in a direction including the direction in which the protrusion 5 is formed among the directions orthogonal to the extending direction X of the wiring members W. The slits 3 formed on both sides across the wiring members W are formed such that the positions in the extending direction X of the wiring members W are different from each other.

That is, when, among the slits 3 formed on both sides across the wiring members W, the slits 3 formed on the side where the protrusion 5 is located with respect to the wiring members W are defined as first slits 3a and the slits 3 formed on the side opposite to the side where the protrusion 5 is located with respect to the wiring members W are defined as second slits 3b, the positions of the first slits 3a and the second slits 3b in the extending direction X of the wiring members W are different from each other. In the present embodiment, the plurality of first slits 3a and the plurality of second slits 3b formed in the molded member 1 are alternately formed in the extending direction X of the wiring members W.

In addition, the plurality of first slits 3a is disposed at equal intervals on both sides of the protrusion 5 in the extending direction X of the wiring members W. Similarly, the plurality of second slits 3b is disposed at equal intervals on both sides of the protrusion 5 in the extending direction X of the wiring members W.

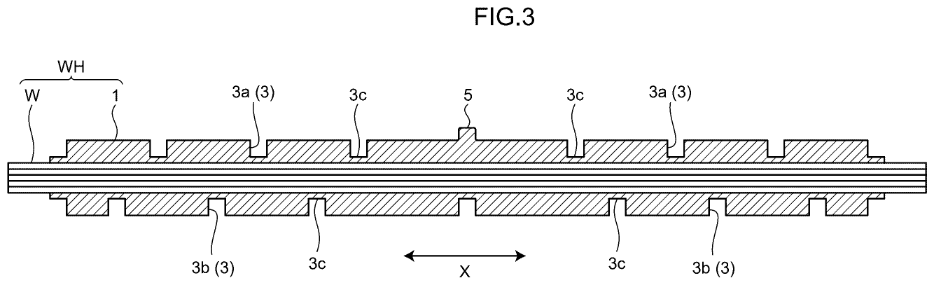

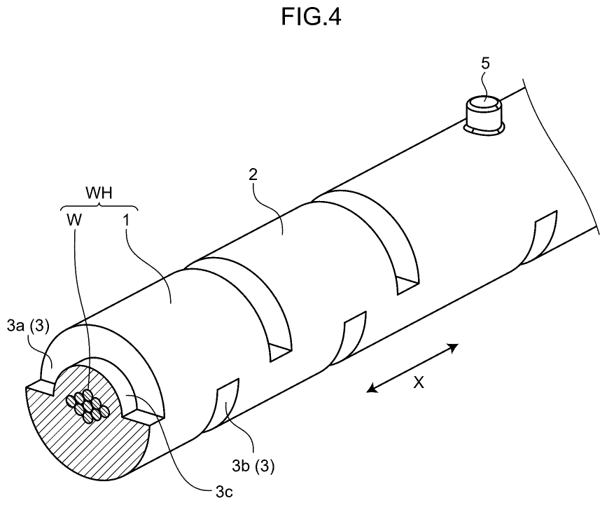

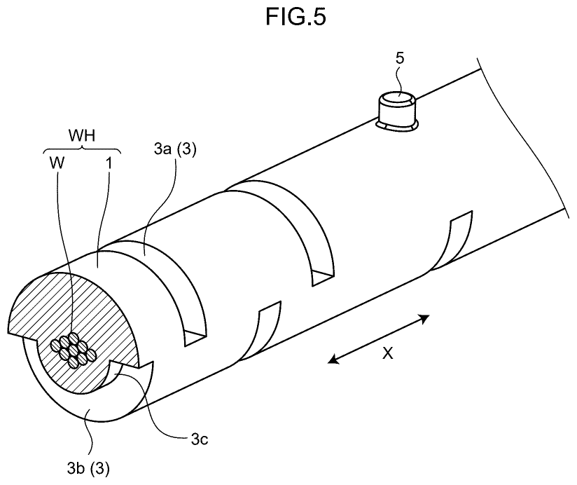

FIG. 3 is a cross-sectional view taken along line A-A of FIG. 1. FIG. 4 is a perspective view of a main part including a cross section taken along line B-B in FIG. 1. FIG. 5 is a perspective view of a main part including a cross section taken along line C-C in FIG. 1. When both the first slits 3a and the second slits 3b are viewed in the extending direction X of the wiring members W, the slits 3 formed in the molded member 1 are formed in half circumferential ranges about the axial center of the cylinder that is the shape of the molded member 1, that is, in a range of about 180°. As described above, the first slits 3a and the second slits 3b formed in the half circumferential ranges of the cylinder are formed such that the positions in the circumferential direction about the axial center of the cylinder are different from each other, and are formed in ranges not substantially overlapping each other in the circumferential direction.

In addition, for both the first slits 3a and the second slits 3b, the shapes of bottom portions 3c of the slits 3 are formed in a substantially arc shape that is concentric with the outer surface 2 of the molded member 1 when viewed in the extending direction X of the wiring members W. Further, the depth of the slits 3 from the outer surface 2 of the molded member 1 to the bottom portions 3c of the slits 3 is shallower than the depth from the outer surface 2 of the molded member 1 to the position where the wiring members W are disposed. That is, the wiring members W are disposed at a position where the depth from the outer surface 2 of the molded member 1 is deeper than the depth from the outer surface 2 of the molded member 1 to the bottom portions 3c of the slits 3.

Therefore, a resin material for forming the molded member 1 is interposed between the wiring members W disposed inside the molded member 1 and the bottom portions 3c of the slits 3. As a result, even at the positions where the slits 3 are formed in the extending direction X of the wiring members W, the wiring members W are covered with the resin material forming the molded member 1 and disposed inside the molded member 1 without being exposed inside the slits 3.

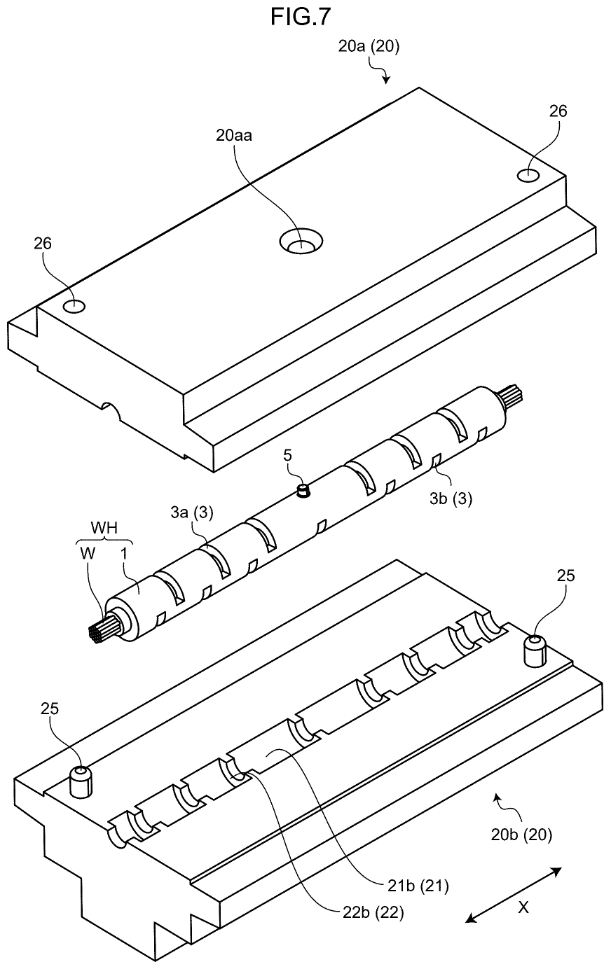

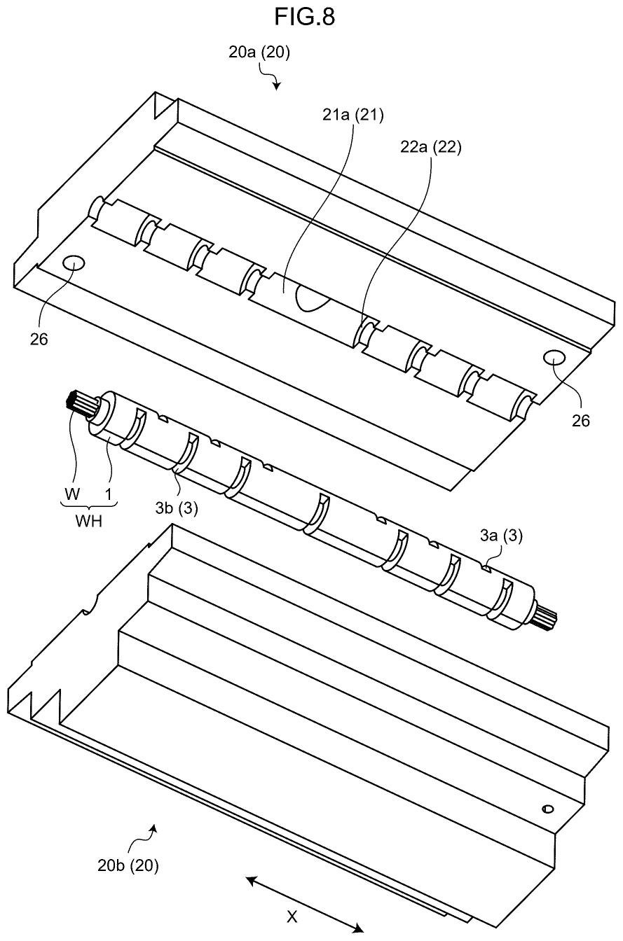

FIG. 6 is a perspective view of the mold 20 used for molding the molded member 1. FIG. 7 is a perspective view illustrating a state in which an upper mold 20a and a lower mold 20b of the mold 20 illustrated in FIG. 6 are separated. FIG. 8 is a perspective view of the upper mold 20a and the lower mold 20b illustrated in FIG. 7 as viewed from the lower mold 20b side. The molded member 1 included in the wire harness WH is molded using the mold 20 including a molding portion 21 for molding the molded member 1. In the present embodiment, the mold 20 includes the upper mold 20a and the lower mold 20b, and molding is performed in a state where the upper mold 20a and the lower mold 20b are stacked in an up-down direction at the time of molding the molded member 1. That is, the upper mold 20a is stacked on the lower mold 20b from above.

A plurality of positioning pins 25 for performing alignment when the upper mold 20a and the lower mold 20b are stacked are disposed on opposing surfaces of the upper mold 20a and the lower mold 20b. The positioning pins 25 are disposed on the lower mold 20b by being fitted to the lower mold 20b, and are formed on a surface of the lower mold 20b that faces the upper mold 20a so as to protrude toward a side where the upper mold 20a is located. Positioning holes 26 are formed in the upper mold 20a at positions corresponding to the positioning pins 25, and positioning is performed by entering the positioning pins 25 into the positioning holes 26 when the upper mold 20a and the lower mold 20b are stacked at the time of molding the molded member 1.

The molding portion 21 for molding the molded member 1 is formed in both the upper mold 20a and the lower mold 20b. Specifically, a first molding portion 21a serving as the molding portion 21 is formed on the surface of the upper mold 20a on the side facing the lower mold 20b, and a second molding portion 21b serving as the molding portion 21 is formed on the surface of the lower mold 20b on the side facing the upper mold 20a. The first molding portion 21a and the second molding portion 21b are formed in shapes capable of molding the outer surface 2 of the molded member 1. Each of the first molding portion 21a and the second molding portion 21b is formed in a shape capable of molding the outer surface 2 in a range of about 180° in the circumferential direction of the cylinder that is the shape of the molded member 1.

Ribs 22 for forming the slits 3 with respect to the molded member 1 are disposed in the molding portion 21 of the mold 20. In the first molding portion 21a, first ribs 22a that are ribs 22 for molding the first slits 3a in the molded member 1 are disposed, and in the second molding portion 21b, second ribs 22b that are ribs 22 for molding the second slits 3b in the molded member 1 are disposed. The first ribs 22a and the second ribs 22b are each formed at a constant height from the surfaces of the first molding portion 21a and the second molding portion 21b that mold the outer surface 2 of the molded member 1.

In addition, an insertion hole 20aa, which is a hole into which a nozzle (not illustrated) of an injection device (not illustrated) is inserted when the resin material is injected into the mold 20 at the time of molding the molded member 1, is formed in the upper mold 20a. The insertion hole 20aa is formed as a hole communicating with the first molding portion 21a from a surface of the upper mold 20a on a side opposite to the surface facing the lower mold 20b.

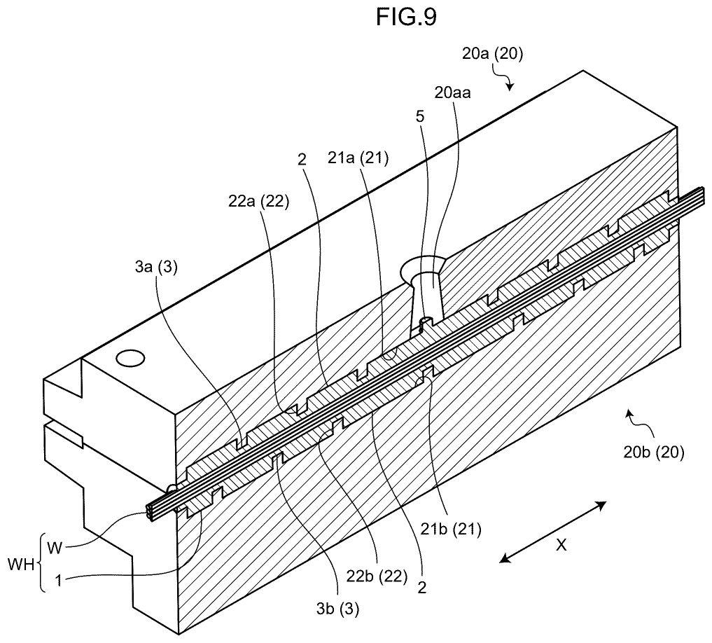

Next, molding of the molded member 1 performed using the mold 20 will be described. FIG. 9 is a cross-sectional view of the mold 20 illustrated in FIG. 6 at a position of the wire harness WH. When the molded member 1 is molded using the mold 20, the upper mold 20a and the lower mold 20b are stacked in a state where the wiring members W pass through the inside of the first molding portion 21a of the upper mold 20a and the second molding portion 21b of the lower mold 20b. At this time, since the first ribs 22a are formed on the first molding portion 21a of the upper mold 20a and the second ribs 22b are formed on the second molding portion 21b of the lower mold 20b, the wiring members W are disposed inside the molding portion 21 without being biased toward the upper mold 20a side or the lower mold 20b side.

That is, since the first ribs 22a are formed on the first molding portion 21a, the movement of the wiring members W toward the side where the upper mold 20a is located is restricted by the first ribs 22a, and the bias of the wiring members W toward the upper mold 20a is restricted by the first ribs 22a. Similarly, since the second ribs 22b are formed on the second molding portion 21b, the movement of the wiring members W toward the side where the lower mold 20b is located is restricted by the second ribs 22b, and the bias of the wiring members W toward the lower mold 20b is restricted by the second ribs 22b.

In addition, since the first ribs 22a and the second ribs 22b are formed at a constant height from the surfaces of the first molding portion 21a and the second molding portion 21b that mold the outer surface 2 of the molded member 1, the bias of the wiring members W in each direction orthogonal to the extending direction X of the wiring members W is also restricted by the first ribs 22a and the second ribs 22b. As a result, the wiring members W disposed inside the molding portion 21 are disposed at a position near the axial center of the cylinder that is the shape of the molded member 1.

When the molded member 1 is molded using the mold 20, the wiring members W are passed through the inside of the molding portion 21 as described above, and a molten resin material is injected into the molding portion 21 in a state where the upper mold 20a and the lower mold 20b are stacked. In the injection of the resin material into the molding portion 21, the nozzle of the injection device is inserted into the insertion hole 20aa formed in the upper mold 20a, and the molten resin material is ejected from the nozzle to eject the resin material into the molding portion 21. As a result, the space formed by the first molding portion 21a of the upper mold 20a and the second molding portion 21b of the lower mold 20b is filled with the resin material.

The resin material poured into the molding portion 21 is cured by being cooled as a result of the passage of time. As a result, the resin material is formed as the molded member 1 in which the wiring members W are disposed and that covers the wiring members W. When the resin material in the molding portion 21 is cured and the resin material is formed as the molded member 1, the upper mold 20a and the lower mold 20b are separated from each other to take out the molded member 1 molded by the mold 20.

Here, since the positions of the ribs 22 formed on the molding portion 21 of the mold 20 are not filled with the resin material, the portions of the molding portion 21 where the ribs 22 are disposed are formed as the slits 3 in the molded member 1. That is, the portions of the first molding portion 21a where the first ribs 22a are disposed are formed as the first slits 3a in the molded member 1, and the portions of the second molding portion 21b where the second ribs 22b are disposed are formed as the second slits 3b in the molded member 1. As a result, the plurality of slits 3 arranged in the extending direction X of the wiring members W is formed in the molded member 1 molded by the mold 20. Note that depending on the posture of the wiring members W when the molded member 1 is injection-molded with respect to the wiring members W, some of the wiring members W abut on the ribs 22 during molding, so that some of the wiring members W may be exposed to the bottom portion 3c side in the slits 3.

The wire harness WH including the molded member 1 molded using the mold 20 as described above is routed to any portion of the vehicle or the like. At this time, the molded member 1 includes the plurality of slits 3, so that the molded member 1 is easily bent. Therefore, the wire harness WH can be easily routed by bending the molded member 1 as necessary according to the state of the periphery of the portion where the molded member 1 is disposed.

In addition, since the protrusion 5 is formed on the molded member 1, positioning can be performed by the protrusion 5 when the molded member 1 is disposed at any position. Accordingly, when the wire harness WH is routed, the molded member 1 can be disposed at an appropriate position.

In the wire harness WH according to the embodiment described above, the molded member 1 provided integrally with the wiring members W to cover the wiring members W includes the plurality of slits 3 formed from the outer surface 2 of the molded member 1 toward the side on which the wiring members W are located. Therefore, when the molded member 1 is molded using the mold 20, the position of the wiring members W with respect to the molded member 1 can be restricted by the ribs 22 of the mold 20 for forming the slits 3 of the molded member 1. As a result, by molding the molded member 1 using the mold 20, it is possible to dispose the wiring members W at an appropriate position in the molded member 1 without manually adjusting the position of the wiring members W while covering any position of the wiring members W with the molded member 1. As a result, the disposition position of the wiring members W with respect to the molded member 1 can be easily disposed at an appropriate position, and the molded member 1 can be attached to the wiring members W.

In addition, since the slits 3 formed in the molded member 1 are orthogonal to the extending direction X of the wiring members W, the molded member 1 can be easily bent in the direction orthogonal to the extending direction X of the wiring members W. As a result, when the molded member 1 is injection-molded with respect to the wiring members W, the molded member 1 can more suitably suppress the loosening of the wiring members W with the ribs 22 that form the slits 3. In addition, when the molded member 1 is disposed at any position, it is possible to improve the disposition property by bending the molded member 1 as necessary. As a result, the ease of routing the wire harness WH can be enhanced.

In addition, since the slits 3 are formed on both sides of the molded member 1 across the wiring members W, the molded member 1 can be easily bent toward the sides where both slits 3 are disposed. That is, since the molded member 1 includes the first slits 3a and the second slits 3b formed on the opposite sides of the molded member 1, when the molded member 1 is injection-molded with respect to the wiring members W, it is possible to more suitably suppress the loosening of the wiring members W from both sides by the first ribs 22a forming the first slits 3a and the second ribs 22b forming the second slits 3b. In addition, since the molded member 1 includes the first slits 3a and the second slits 3b, the molded member 1 can be easily bent toward the side where the first slits 3a are disposed and the side where the second slits 3b are disposed. As a result, since the direction in which the molded member 1 can be bent when the molded member 1 is disposed at any position is a plurality of directions, the disposition property of the molded member 1 can be enhanced. As a result, the ease of routing the wire harness WH can be enhanced.

In addition, since the slits 3 on both sides across the wiring members W are formed at positions different from each other in the extending direction X of the wiring members W, the slits 3 can be easily provided on both sides across the wiring members W. As a result, it is possible to easily bend the molded member 1 in the plurality of directions, and thus it is possible to improve the disposition property when the molded member 1 is disposed at any position. As a result, the ease of routing the wire harness WH can be enhanced.

In addition, since the plurality of first slits 3a and the plurality of second slits 3b formed in the molded member 1 are alternately formed in the extending direction X of the wiring members W, it is possible to improve the bending property when bending the molded member 1. That is, the first slits 3a and the second slits 3b are alternately formed in the extending direction X of the wiring members W, the molded member 1 can be bent with a small curvature radius as a curvature radius at the time of bending. Accordingly, it is possible to enhance the disposition property when the molded member 1 is disposed at any position. As a result, the ease of routing the wire harness WH can be enhanced.

### Modifications

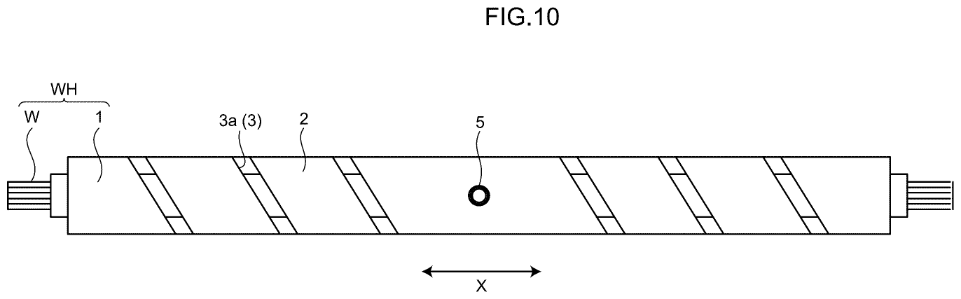

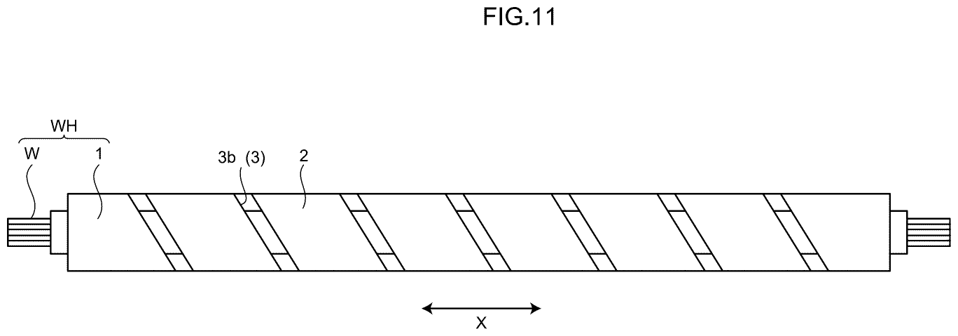

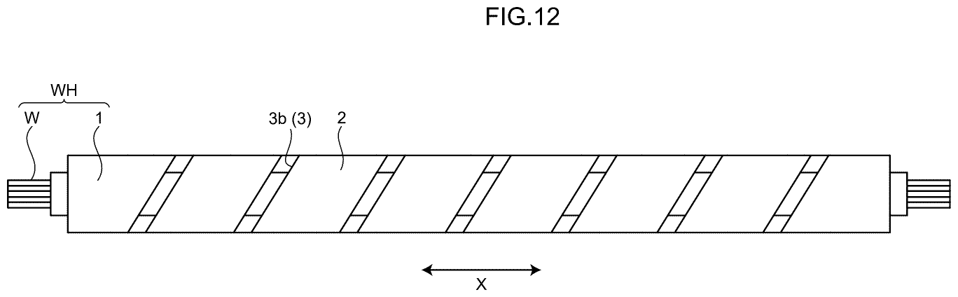

Note that, in the above-described embodiment, the slits 3 formed in the molded member 1 are formed in the orientation orthogonal to the extending direction X of the wiring members W, but the slits 3 may be formed in an orientation other than the above. FIG. 10 is a plan view of the molded member 1 in which the slits 3 are inclined with respect to the extending direction X of the wiring members W, which is a modification of the wire harness WH according to the embodiment. FIG. 11 is a plan view of the molded member 1 in which the second slits 3b are inclined in the same direction as the first slits 3a, which is a modification of the wire harness WH according to the embodiment. FIG. 12 is a plan view of the molded member 1 in which the second slits 3b are inclined in a direction different from that of the first slits 3a, which is a modification of the wire harness WH according to the embodiment. For example, as illustrated in FIGS. 10 to 12, the plurality of slits 3 formed in the molded member 1 may be formed to be inclined with respect to the extending direction X of the wiring members W and a direction orthogonal to the extending direction X of the wiring members W. That is, as illustrated in FIG. 10, the plurality of first slits 3a formed in the molded member 1 may be formed to be inclined with respect to the extending direction X of the wiring members W and the direction orthogonal to the extending direction X of the wiring members W.

In this case, the second slits 3b formed on the side opposite to the side where the first slits 3a are formed in the molded member 1 may be inclined in the same direction as the direction in which the first slits 3a are inclined with respect to the extending direction X of the wiring members Was illustrated in FIG. 11, or the second slits 3b may be inclined in a direction different from the direction in which the first slits 3a are inclined with respect to the extending direction X of the wiring members W as illustrated in FIG. 12.

Since the slits 3 of the molded member 1 are formed to be inclined with respect to the extending direction X of the wiring members W, it is possible to bend the molded member 1 in an oblique direction according to the direction of inclination of the slits 3 when the molded member 1 is bent. Thus, for example, when the plurality of slits 3 is inclined in the same direction with respect to the extending direction X of the wiring members W, the molded member 1 can be bent in a spiral shape as a whole by bending the molded member 1 in the same oblique direction at each position of the slit 3. By inclining the slits 3 with respect to the extending direction X of the wiring members W in this manner, the direction in which the molded member 1 bends can be an oblique direction, and therefore, by inclining the slits 3 according to the disposition position of the molded member 1, the molded member 1 can be bent according to the disposition position of the molded member 1. Therefore, it is possible to enhance the disposition property when the molded member 1 is disposed at any position. As a result, the ease of routing the wire harness WH can be enhanced.

Note that when the slits 3 are formed to be inclined with respect to the extending direction X of the wiring members W, not all the slits 3 formed in the molded member 1 may be inclined with respect to the extending direction X of the wiring members W. Among the plurality of slits 3 formed in the molded member 1, some of the slits 3 may be inclined with respect to the extending direction X of the wiring members W, and the other slits 3 may be orthogonal to the extending direction X of the wiring members W. Since the slits 3 formed in the molded member 1 affect the bending direction of the molded member 1, the plurality of slits 3 is preferably formed at an appropriate angle for each slit 3 according to the disposition position and disposition form of the molded member 1.

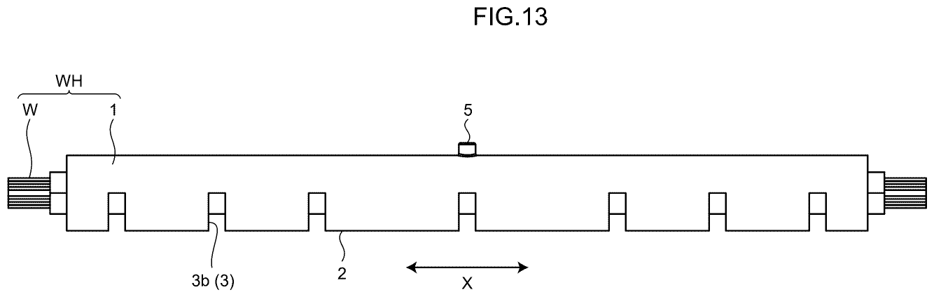

In addition, in the above-described embodiment, the slits 3 are formed on both sides of the molded member 1 across the wiring members W, but the slits 3 may be formed only at a position on one side of the molded member 1 in a direction orthogonal to the extending direction X of the wiring members W. FIG. 13 is a side view of the molded member 1 in which the second slits 3b are formed, which is a modification of the wire harness WH according to the embodiment. For example, as illustrated in FIG. 13, the plurality of slits 3 formed in the molded member 1 may include only the second slits 3b without including the first slits 3a. In the molded member 1, since the second slits 3b are formed at the position on one side of the molded member 1 in the direction orthogonal to the extending direction X of the wiring members W, the ease of bending of the molded member 1 can be ensured.

In addition, since the slits 3 are not formed at the position on the other side of the molded member 1 in the direction orthogonal to the extending direction X of the wiring members W, the protection performance of the wiring members W on the side where the slits 3 are not formed can be enhanced. Thus, when the side on which the protection performance of the wiring members W is desired to be improved in the molded member 1 is preset, the protection performance of the wiring members W and the easiness of bending of the molded member 1 can be both achieved by forming the slits 3 only on the opposite side without forming the slits 3 on the side on which the protection performance is desired to be improved. As a result, it is possible to achieve both the protection performance of the wiring members W by the molded member 1 and the ease of routing of the wire harness WH.

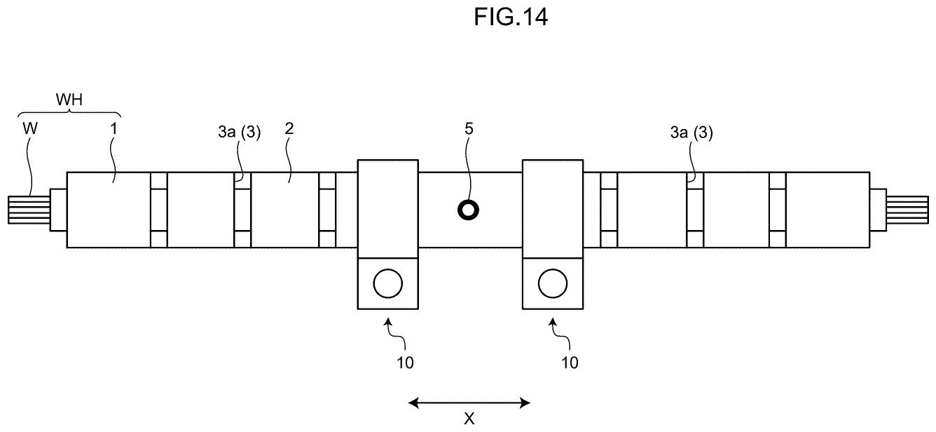

In addition, in the above-described embodiment, the slits 3 formed in the molded member 1 are formed over the entire range in the extending direction X of the wiring members W, but the slits 3 may not be formed over the entire range of the molded member 1. FIG. 14 is a plan view of the molded member 1 in which fixing portions 10 for attaching the molded member 1 to an attachment target portion are disposed, which is a modification of the wire harness WH according to the embodiment. When the fixing portions 10 for attaching the molded member 1 to the attachment target portion are disposed on the molded member 1 as illustrated in FIG. 14, the slits 3 are preferably formed at positions other than the positions where the fixing portions 10 are disposed on the molded member 1.

The attachment target portion in this case is a portion of the vehicle to which the molded member 1 is attached. The fixing portions 10 include, for example, clamps, clips, or the like, and can be attached to the attachment target portion directly or by using bolts or the like with respect to the attachment target portion. Note that the fixing portions 10 may not be separated from the molded member 1, and may be formed integrally with the molded member 1.

As described above, the fixing portions 10 are disposed on the molded member 1, and the slits 3 are not provided at the positions where the fixing portions 10 are disposed on the molded member 1, whereby the strength of the vicinity of the fixing portions 10 on the molded member 1 can be secured. As a result, it is possible to secure the attachment strength when the molded member 1 is attached to the attachment target portion by the fixing portions 10.

In addition, since the slits 3 are formed at positions other than the positions where the fixing portions 10 are disposed on the molded member 1, it is possible to restrict the bias of the wiring members W by the ribs 22 in the mold 20 that form the slits 3. As a result, the wiring members W can be disposed at an appropriate position in the molded member 1. In addition, since the slits 3 are formed at positions other than the positions where the fixing portions 10 are disposed on the molded member 1, the molded member 1 can be easily bent, so that the disposition property of the molded member 1 can be enhanced. As a result, the disposition position of the wiring members W with respect to the molded member 1 can be easily disposed at appropriate positions to attach the molded member 1 to the wiring members W, and the attachment strength of the molded member 1 and the ease of routing the wire harness WH can be enhanced.

In addition, in the above-described embodiment, six first slits 3a and seven second slits 3b are formed in the molded member 1, but the number of first slits 3a and the number of second slits 3b may be other than the above. In addition, in the above-described embodiment, the first slits 3a and the second slits 3b are disposed at equal intervals on both sides of the protrusion 5 in the extending direction X of the wiring members W, but the first slits 3a and the second slits 3b may not be disposed at equal intervals.

In addition, in the above embodiment, when the side of the molded member 1 on which the protrusion 5 is located is the upper side, the first slits 3a are formed on the upper side, and the second slits 3b are formed on the lower side, but the first slits 3a and the second slits 3b may be formed at positions other than the upper side and the lower side. The first slits 3a and the second slits 3b may be formed on side surfaces where the first slits 3a and the second slits 3b opposite to each other when the side of the molded member 1 on which the protrusion 5 is located is the upper side. The first slits 3a and the second slits 3b are preferably disposed as appropriate in accordance with the position where the molded member 1 is disposed, the manner of bending the molded member 1 according to the disposition form, and the like.

In addition, in the above-described embodiment, the molded member 1 directly covers the wiring members W, but the molded member 1 may cover the wiring members W covered with an insulating coating or an outer coating. As long as the molded member 1 can cover a partial section of the wiring members W, the presence or absence of the insulating coating or the outer coating of the wiring members W is irrelevant.

In addition, the wire harnesses according to the embodiment and the modifications of the present invention described above are not limited to the embodiment and the modifications described above, and various changes can be made within the scope described in the claims. The wire harnesses according to the present embodiment and the modifications may be configured by appropriately combining the constituent elements of the embodiment and the modifications described above.

In a wire harness according to the present embodiment, a molded member provided integrally with a wiring member to cover the wiring member includes a plurality of slits formed from an outer surface of the molded member toward a side on which the wiring member is located. Therefore, when the molded member serving as the exterior member of the wiring member is molded using a mold, the position of the wiring member with respect to the molded member can be restricted by ribs for forming the slits of the molded member in the mold. As a result, by molding the molded member using the mold, it is possible to dispose the wiring member at an appropriate position in the molded member without manually adjusting the position of the wiring member while covering any position of the wiring member with the molded member. As a result, there is an effect that the disposition position of the wiring member with respect to the molded member serving as the exterior member of the wiring member can be easily disposed at an appropriate position, and the molded member can be attached to the wiring member.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A wire harness comprising:
a wiring member having conductivity; and
a molded member that covers the wiring member and is provided integrally with the wiring member; and
a protrusion that protrudes from an outer surface of the molded member, wherein
the molded member includes a plurality of slits formed from an outer surface of the molded member toward a side on which the wiring member is located.

2. The wire harness according to claim 1, wherein the slits are orthogonal to an extending direction of the wiring member.

3. The wire harness according to claim 1, wherein the slits are inclined with respect to an extending direction of the wiring member and a direction orthogonal to the extending direction of the wiring member.

4. The wire harness according to claim 2, wherein the slits are formed on both sides of the molded member across the wiring member.

5. The wire harness according to claim 3, wherein the slits are formed on both sides of the molded member across the wiring member.

6. The wire harness according to claim 4, wherein the slits on both sides across the wiring member are formed such that positions in the extending direction of the wiring member are different from each other.

7. The wire harness according to claim 5, wherein the slits on both sides across the wiring member are formed such that positions in the extending direction of the wiring member are different from each other.

8. The wire harness according to claim 2, wherein the slits are formed only at positions on one side of the molded member in a direction orthogonal to the extending direction of the wiring member.

9. The wire harness according to claim 3, wherein the slits are formed only at positions on one side of the molded member in a direction orthogonal to the extending direction of the wiring member.

10. The wire harness according to claim 2, wherein
a fixing portion for attaching the molded member to an attachment target portion is disposed on the molded member, and
the slits are formed at positions other than position where the fixing portion is disposed on the molded member.

11. The wire harness according to claim 3, wherein
a fixing portion for attaching the molded member to an attachment target portion is disposed on the molded member, and
the slits are formed at positions other than position where the fixing portion is disposed on the molded member.
